(19) United States
(12) Patent Application Publication
(10) Pub. No.: US 2012/0254790 A1
(43) Pub. Date: Oct. 4, 2012

(54) DIRECT, FEATURE-BASED AND MULTI-TOUCH DYNAMIC SEARCH AND MANIPULATION OF IMAGE SETS

(75) Inventors: Tommaso Colombino, Grenoble (FR); Gabriela Csurka, Crolles (FR); Luca Marchesotti, Grenoble (FR); Yves Hoppenot, Notre-Dame-de-Mesage (FR)

(73) Assignee: Xerox Corporation, Norwalk, CT (US)

(21) Appl. No.: 13/076,548

(22) Filed: Mar. 31, 2011

(51) Int. Cl. G06F 3/048

(52) U.S. Cl. 715/781

(57) ABSTRACT

A system and method for manipulating graphic objects on a tactile user interface are provided. The graphic objects can be photographic images which are retrieved in response to a query and are clustered, based on values of first and second user-selected features assigned to the graphic objects. A navigation map is displayed on the user interface. The navigation map represents the clusters of graphic objects in first and second dimensions, corresponding to the first and second features. A user can manipulate a target window displayed on the navigation map using the tactile user interface. The target window encompasses a subset of the clustered graphic objects. A synchronized display of graphic objects in the subset of graphic objects on the user interface corresponds to the subset of clustered graphic objects within the displayed target window.

### CROSS REFERENCE TO RELATED PATENTS AND APPLICATIONS

The following copending applications, the disclosures of which are incorporated herein by reference in their entireties, are mentioned:

U.S. application Ser. No. 12/710,783, filed on Feb. 23, 2010, entitled SYSTEM AND METHOD FOR INFORMATION SEEKING IN A MULTIMEDIA COLLECTION, by Julien Ah-Pine, et al.;

U.S. application Ser. No. 12/693,795, filed on Jan. 26, 2010, entitled A SYSTEM FOR CREATIVE IMAGE NAVIGATION AND EXPLORATION, by Sandra Skaff, et al.;

U.S. patent application Ser. No. 12/632,107, filed Dec. 7, 2009, entitled SYSTEM AND METHOD FOR CLASSIFICATION AND SELECTION OF COLOR PALETTES, by Luca Marchesotti, et al.;

U.S. patent application Ser. No. 12/908,410, filed on Oct. 20, 2010, entitled CHROMATIC MATCHING GAME, by Luca Marchesotti, et al.;

U.S. patent application Ser. No. 12/976,196, filed on Dec. 22, 2010, entitles SYSTEM AND METHOD FOR COLLABORATIVE GRAPHICAL SEARCHING WITH TANGIBLE QUERY OBJECTS ON A MULTI-TOUCH TABLE, by Yves Hoppenot, et al.; and

U.S. patent application Ser. No. 13/031,336, filed on Feb. 21, 2011, entitled QUERY GENERATION FROM DISPLAYED TEXT DOCUMENTS USING VIRTUAL MAGNETS, by Caroline Privault, et al.

### BACKGROUND

The exemplary embodiment relates to the visual display arts. It finds particular application in connection with a system and method for facilitating user interaction with a set of graphic objects, such as images.

Retrieving images for graphic design applications from a large collection of images often entails a compromise between delimiting the search space through explicit criteria (exploitation) and browsing a sufficient number of images out of the total available to ensure the appropriate ones are not missed (exploration). While most image collections are tagged and allow users to perform targeted, textual-query based searches, the image browsing interfaces typically provided to search through the results of a query are limited to a thumbnail viewing pane where each page of results has to be loaded into the browser with little or no opportunity to rank or organize the search space according to features and criteria that may help the user converge on the relevant images.

Searching the results of a tag-based query with existing tools is consequently akin to browsing through a “list” of results where the ordering cannot be changed. Typical users will review only the first few pages of images, such as, for example, at most about 250 images, out of a subset of retrieved images which, depending on the specificity of the query, may number in the tens of thousands. The user may therefore miss a large number of potentially relevant images.

There remains a need for a system which facilitates targeted browsing of images in a large search space.

### INCORPORATION BY REFERENCE

The following references, the disclosures of which are incorporated herein by reference in their entireties, are mentioned.

Image retrieval systems are disclosed, for example, in U.S. Pat. No. 6,577,759, issued Jun. 10, 2003, entitled SYSTEM AND METHOD FOR PERFORMING REGION-BASED IMAGE RETRIEVAL USING COLOR-BASED SEGMENTATION, by Cedric Y Caron, et al.; U.S. Pat. No. 7,529,732, issued May 5, 2009, entitled IMAGE RETRIEVAL SYSTEMS AND METHODS WITH SEMANTIC AND FEATURE BASED RELEVANCE FEEDBACK, by Wen-Yin Liu, et al.; U.S. Pat. No. 7,546,293, issued Jun. 9, 2009, entitled RELEVANCE MAXIMIZING, ITERATION MINIMIZING, RELEVANCE-FEEDBACK, CONTENT-BASED IMAGE RETRIEVAL (CBIR), by Hong-Jiang Zhang; and U.S. Pub. No. 20090125487, published May 14, 2009, entitled CONTENT BASED IMAGE RETRIEVAL SYSTEM, COMPUTER PROGRAM PRODUCT, AND METHOD OF USE, by Adam Rossi, et al.

Methods for displaying and browsing images are disclosed for example, in U.S. Pat. No. 7,764,849, issued Jul. 27, 2010, entitled USER INTERFACE FOR NAVIGATING THROUGH IMAGES, by Aguera y Arcas; and U.S. Pub. No. 20100128058, published May 27, 2010, entitled IMAGE VIEWING APPARATUS AND METHOD, by Akihiro Kawabata, et al.

### BRIEF DESCRIPTION

In accordance with one aspect of the exemplary embodiment, a method for manipulation of a set of graphic objects is provided. The method includes displaying a navigation map on a user interface. The navigation map represents a set of graphic objects. A user can manipulate a target window which is displayed on the navigation map. The window encompasses only a subset of the graphic objects. Graphic objects in the subset are displayed on the user interface in synchronization with the displayed target window.

In another aspect, a system for manipulation of graphic objects includes a user interface which includes a display device and memory which stores instructions. The instructions include instructions for displaying a navigation map on the display device. The navigation map represents a set of graphic objects. Instructions are provided for interpreting signals representative of user touches on the display device as manipulation of a target window which is displayed on the navigation map, and moving the target window in response thereto. The window encompasses only a subset of the graphic objects. Instructions are also provided for displaying graphic objects in the subset of graphic objects on the display device. The display of the graphic objects changes in synchronization with the movement of the target window. A computer processor in communication with the memory implements the instructions.

In another aspect, a method includes retrieving a set of graphic objects and clustering the graphic objects into clusters, based on values of first and second user-selected features assigned to the graphic objects. A navigation map is displayed on a user interface which represents the clusters of graphic objects as an array of cluster objects arranged in first and second dimensions corresponding to the first and second features. Signals representative of user manipulation of a target window which is displayed on the navigation map are received. The displayed target window encompasses only a subset of the cluster objects. Graphic objects in the subset of graphic objects are displayed on the user interface corresponding to the subset of cluster objects within the displayed target window.

### BRIEF DESCRIPTION OF THE DRAWINGS

FIG. 1 is a top plan view of a user interface for manipulation of graphic objects in accordance with one aspect of the exemplary embodiment;

FIG. 2 is a schematic view of system for manipulation of graphic objects incorporating the interface of FIG. 1, in accordance with another aspect of the exemplary embodiment;

FIG. 3 is an enlarged view of the navigation map of FIG. 1;

FIG. 4 is an enlarged view of the filtering dial of FIG. 1;

FIG. 5 illustrates opening an image in preview mode on the user interface;

FIG. 6 illustrates an opened graphic object and its associated meta data and user selection of a portion of the image using a two finger gesture;

FIG. 7 is a flow diagram illustrating a method for image manipulation in accordance with another aspect of the exemplary embodiment; and

FIG. 8 illustrates building a weighted query on the user interface of FIG. 1.

### DETAILED DESCRIPTION

Aspects of the exemplary embodiment relate to a system and method which provide an interaction mechanism that allows a direct, feature-based and multi-touch manipulation of tagged or untagged image sets. The exemplary interaction mechanism has several advantages. For example, it combines and extends the advantages of direct manipulation (direct representation of objects and actions, intuitiveness of controls and of manipulations) from the level of direct manipulation of graphic objects (e.g., image thumbnails) to the level of direct manipulation of the entire search space. It also makes the heuristics of content-based image processing technology transparent to the user by integrating the technology in a browsing mechanism that displays the distribution and organizing properties of features across the entire data set. This makes the features more useful and usable by bridging the semantic gap between what the features represent from computational point of view and what they represent visually to the user.

A “graphic object” comprises an electronic (e.g., digital) recording of information which includes image data comprising color information in the form of colors, such as pixels in the case of digital images and color swatches in the case of color palettes. In its electronic form, a graphic object may also include different modalities such as text content, audio data, or a combination thereof in combination with the image data. Text content may be computer generated from a predefined character set and can be extracted, for example, by optical character recognition (OCR) or the like or may be associated with the graphic object in the form of metadata, such as GPS tags, comments, and the like. Audio content can be stored as embedded audio content or as linked files, for example linked *.wav, *.mp3, or *.ogg files.

A “digital image” (or simply “image”) can be in any convenient file format, such as JPEG, Graphics Interchange Format (GIF), JBIG, Windows Bitmap Format (BMP), Tagged Image File Format (TIFF), JPEG File Interchange Format (JFIF), Delrin Winfax, PCX, Portable Network Graphics (PNG), DCX, G3, G4, G3 2D, Computer Aided Acquisition and Logistics Support Raster Format (GALS), Electronic Arts Interchange File Format (IFF), IOCA, PCD, IGF, ICO, Mixed Object Document Content Architecture (MO:DCA), Windows Metafile Format (WMF), ATT, (BMP), BRK, CLP, LV, GX2, IMG(GEM), IMG(Xerox), IMT, KFX, FLE, MAC, MSP, NCR, Portable Bitmap (PBM). Portable Greymap (PGM), SUN, PNM, Portable Pixmap (PPM), Adobe Photoshop (PSD), Sun Rasterfile (RAS), SGI, X BitMap (XBM), X PixMap (XPM), X Window Dump (XWD), AFX, Imara, Exif, WordPerfect Graphics Metafile (WPG), Macintosh Picture (PICT), Encapsulated PostScript (EPS), video files such as *.mov, *.mpg, *.rm, or *.mp4 files, or other common file format used for images and which may optionally be converted to another suitable format prior to processing. Digital images may be individual photographs, graphics, video images, or combinations thereof. In general, each digital image includes image data for an array of pixels forming the image. In displaying or processing an image, a reduced pixel resolution version (“thumbnail”) or low-resolution preview visualization of a stored digital image may be used, which, for convenience of description, is considered to be the image.

A “color palette,” as used herein, is a limited set of different colors, which may be displayed as an ordered or unordered sequence of swatches, one for each color in the set. A “predefined color palette” is a color palette stored in memory. The colors in a predefined color palette may have been selected by a graphic designer, or other skilled artisan working with color, to harmonize with each other, when used in various combinations. In general, the predefined color palettes each include at least two colors, such as at least three colors, e.g., up to thirty colors, such as three, four, five, or six different colors.

While graphic objects are often referred to herein as images, such as still photographic images, it is to be appreciated that other types of graphic object, such as color palettes, videos, and combinations thereof are also contemplated.

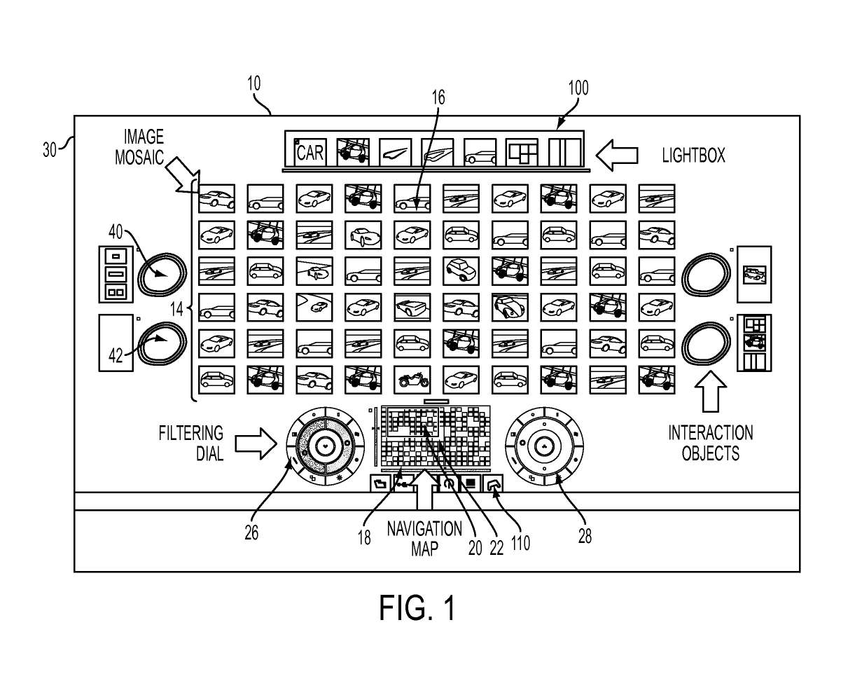

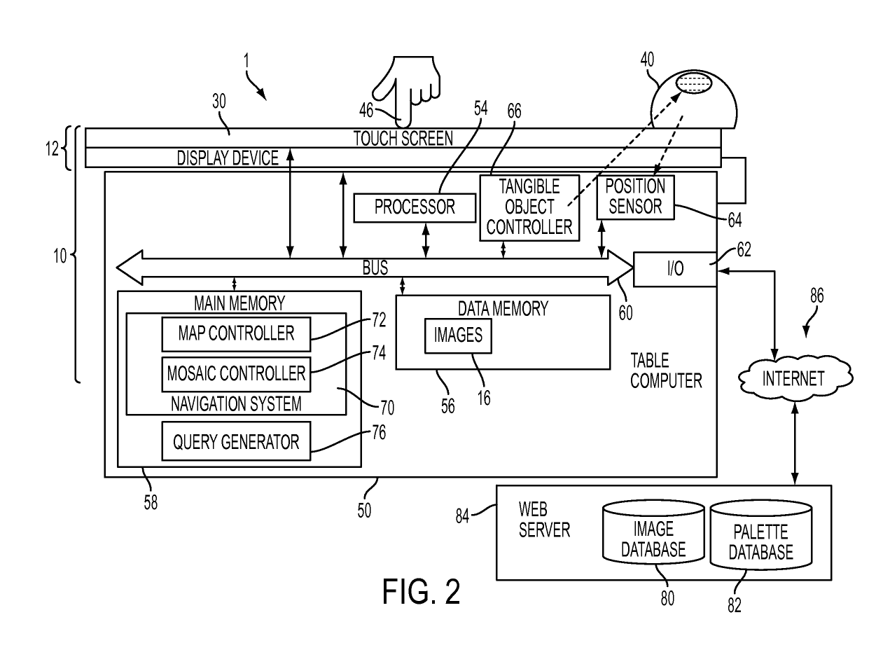

FIGS. 1 and 2 illustrate an exemplary system 1 which incorporates a user interface 10 including a display device 12, in accordance with one aspect of the exemplary embodiment. The exemplary user interface 10 is a tactile user interface (TUI) 10, which allows users to navigate easily through interactive content on the multi-touch display device 12. The user interface can be an interactive table device, multi-touch tablet computer, touch screen monitor of a PC or laptop, multi-touch tablet PC, or the like. The display device 12 incorporates a touch-screen which detects movements, such as those of a user's hand or an implement held by the user. The detected movements (gestures) are translated into commands to be performed, in a similar manner to conventional user interfaces which employ keyboards, cursor control devices, and the like.

The system incorporating the user interface 10, provides a browsing mechanism which combines a visual representation 14 of the content of a subset of graphic objects 16 (e.g., images), with a navigation map 18 (FIG. 1). The navigation map 18 is a visual representation of a distribution of user-selected features over the entire set of images (search space) from which the smaller subset, shown in the visual representation 14, is drawn. The features can be characteristics of the images and/or of associated information, such as visual and aesthetic features.

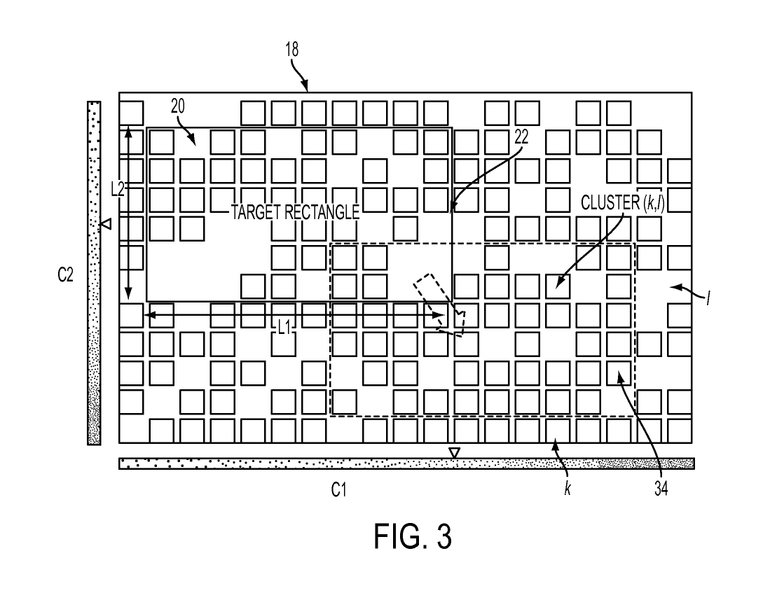

The exemplary image visual representation 14 is in the form of a two dimensional array of images 16, referred to herein as an image mosaic, in which the images 16 (e.g., thumbnails) are arranged in rows and columns, although other arrangements are contemplated. The exemplary feature-based navigation map 18 is shown in greater detail in FIG. 3.

The mosaic 14 and navigation map 18 of the search space are displayed contemporaneously in respective areas of the user interface 10, such that a user can view both at the same time. In particular, the image mosaic 14 represents a detailed view of a specific location 20 on the navigation map 18, which is identified on the navigation map 18 by a target window 22 (FIG. 3). The exemplary target window 22 is shown as a rectangle, although any other regular or irregular shape, such as a square, triangle, circle, or the like, is also contemplated. As the window 22 is moved, the subset of images 16 displayed in the mosaic 14 changes accordingly. The image mosaic 14 and navigation map 18 are thus synchronized. As will be appreciated, by “synchronized,” it is meant that the subset of images 16 displayed reflects the current position of the window 22, bearing in mind that there may be a short delay in matching the subset with the window 22, up to perhaps a one or two second delay, due to one of more of recomputing the subset of images to be displayed, recomputing their arrangement in the mosaic, retrieving the images, possible from a remote memory, and displaying them on the display device 12. However, in general, the delay time can be much shorter, such that the user does not notice any discrepancy between the two.

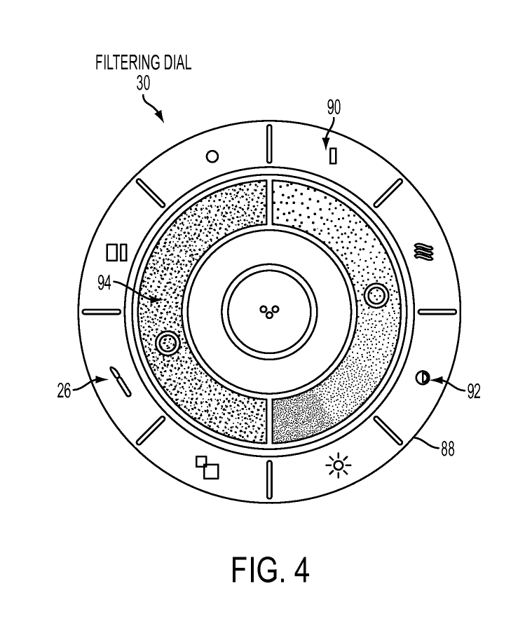

Both the image mosaic 14 and navigation map 18 can be directly and synchronously manipulated using one or more dynamic multi-touch controls 26, 28. In the exemplary embodiment, the controls 26, 28 are graphic objects (virtual dials) that are created by appropriate software. The exemplary controls 26, 28 are displayed on the screen 30 of the multi-touch display device 12, adjacent to the image mosaic 14 and navigation map 18. An exemplary multi-touch control 26 is shown in enlarged view in FIG. 4. The control 26, 28 is operated by two or more discrete touches, generally with fingers of the same hand in a similar gesture to that which would be used in operating a hard knob. In particular, in a recognized adjustment gesture, two or more fingers turn, e.g., move clockwise together (or anticlockwise together). As the user interacts with the control 26, the corresponding movement is reflected in the visualization on the display screen. In particular, the turning of dials 26, 28 is used to move the window 22, within the area of the navigation map 18. While the exemplary controls 26, 28 for the window movement are responsive only to multi touch gestures (two or more fingers), in some embodiments, the controls 26, 28 may be operable by a single touch gesture. As will be appreciated, other controls with suitable gestures are also contemplated, such as a slider bar in which a virtual cursor is moved, through touch gestures along a virtual horizontal or vertical bar. In other embodiments, tangible controls, such as knobs 26, 28, dials, keyboard, keypad, or the like, may be used.

As shown in FIG. 3, the navigation map 18 provides a visual representation of the distribution of first and second features (here illustrated as C₁ and C₂) across the entire set of retrieved images, or even an entire database or databases. In the navigation map 18, the features may be represented by respective orthogonal axes and the images may be represented by an array of clusters 34 (quantized in feature space). The target window 22 encompasses only a subset of the clusters 34. The exemplary target window 22 has a first dimension L1 corresponding to first feature C₁ (e.g., L1 is an integer number of clusters in length) and a second dimension L2 corresponding to second feature C₂ (e.g., L2 is an integer number of clusters in height).

The direct manipulation of the navigation map 18 can be used to re-organize the contents of the thumbnail viewing pane (image mosaic 14) dynamically, by changing (e.g., translating and/or resizing) the area 20 of the navigation map 18 which is encompassed by the target window 22.

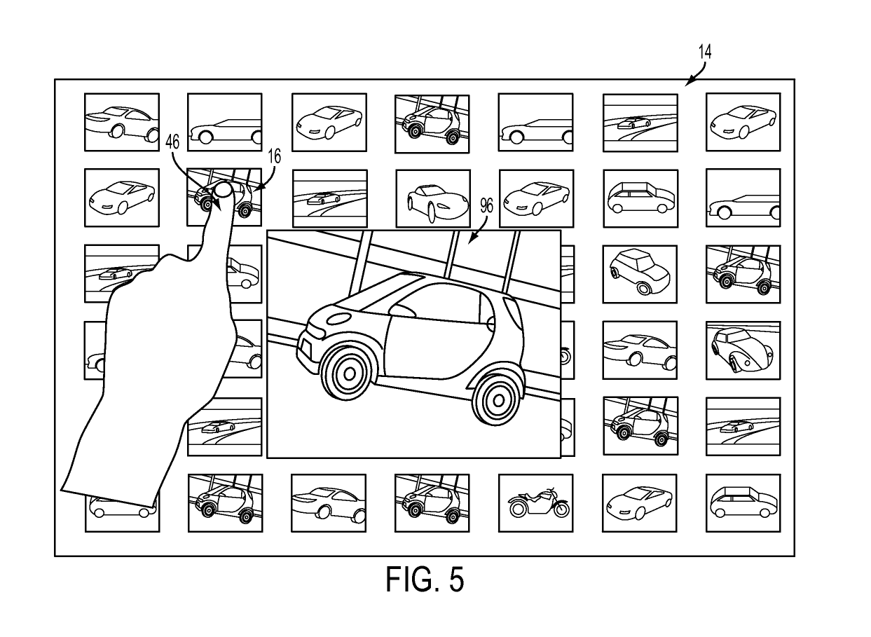

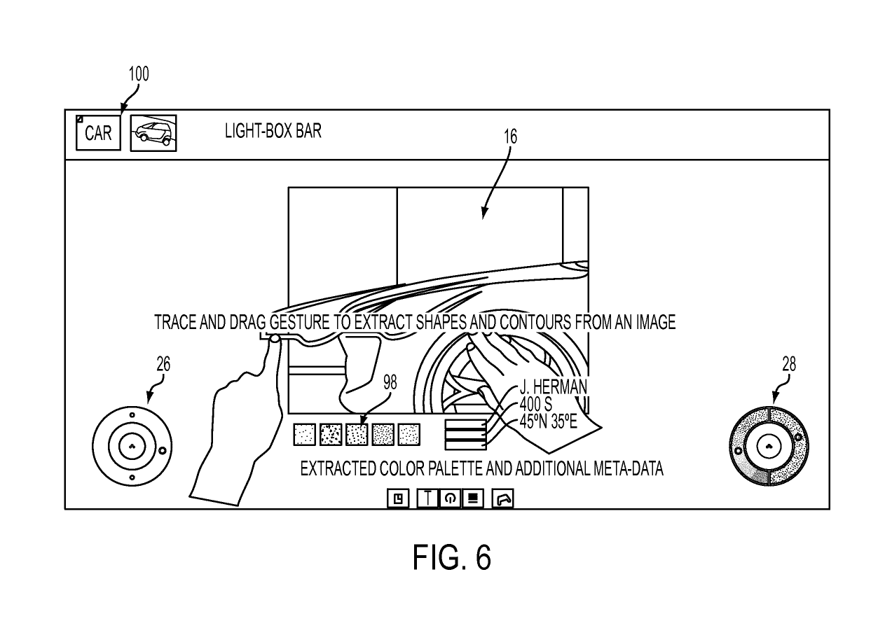

Returning now to FIG. 1, a user can interact with the displayed graphic objects 16 using finger touches and/or touches on the screen 30 of the display device 12 with one or more tangible interaction objects (tangible objects) 40, 42, etc. For example, using a gesture, such as a finger tap, the user can preview or open a graphic object 16 to view it in greater detail (FIGS. 5 and 6). In some embodiments, tangible objects 40, 42 can serve as query objects for building a query based on the displayed graphic objects 16. For example the user brings a tangible query object 40 into contact with the screen over a selected graphic object, which is recognized as “absorbing” the graphic object into the query. The manipulation of the tangible objects 40, 42 on the display device 12 can be substantially as described in copending application Ser. No. 12/976,196 and is only briefly described herein.

With reference now to FIG. 2, one embodiment of an exemplary system 1 for display and manipulation of graphic objects 16 is shown. The system includes the display device 12, such as a color LCD, LED, or plasma screen device. The display device is sensitive to touch of a finger 46 and/or detects contact by a tangible object 40, 42.

The exemplary user interface 10 is in the form of search table, around which several users can gather. The exemplary search table includes a computing device 50 which interacts with the display device 12 and optionally with tangible query objects 40, 42. The display device can be a multi-touch table device which can receive touch inputs from several users at a time, e.g., through finger contact via the touch screen 30 incorporated into the display device 12.

The touch-screen 30 can including multiple actuable areas which are independently responsive to touch or close proximity of an object (touch-sensitive) and can overly or be integral with the screen of the display 12. The actuable areas may be pressure sensitive, heat sensitive, and/or motion sensitive. In one embodiment, the actuable areas may form an array or invisible grid of beams across the touch-screen 30 such that touch contact within different areas of the screen may be associated with different operations. Exemplary touch-sensitive display devices 12 which allow finger-touch interaction, which may be used herein, include the Multi-Touch G²-Touch Screen or G³-Touch Screen from PQ Labs, California (see http://multi-touch-screen.net), an infra-red grid system, such as the iTable from PQ Labs, a camera-based system, such as Microsoft Surface™ touch-screen table (http://www.microsoft.com/surface/). Such a large area device allows a large number of graphic objects to be displayed and manipulated by one or more users through natural gestures. However, it is also contemplated that the display device may have a smaller screen. As will be appreciated, where the finger or implement is detected by a camera rather than through pressure, “detecting a touch contact,” and similar language, implies detecting a finger or tangible object on or near to the screen, which need not necessarily be in physical contact with the screen.

The exemplary computing device 50, which may include two or more communicatively connected computing devices, includes a computer processor 54 and one or more memory storage devices, such as data memory 56 and main memory 58, which are communicatively connected with the processor by a data/control bus 60. The table computer 50 may also include one or more input/output interfaces (I/O) 62 for interacting with external devices. The system may include a presence/position sensor 64 for sensing a position of the tangible object 40 or finger and a controller 66 for causing a visual/audible response to be exhibited by the tangible object 40, as described in copending application Ser. No. 12/976,196. The sensor 64 and controller 66 may be integral with or in communication with the table computer 50.

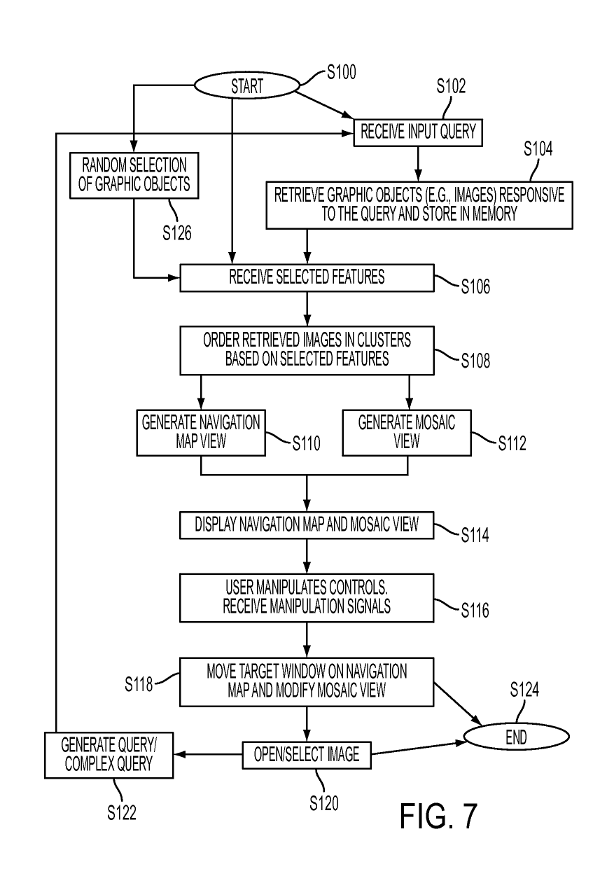

The main memory 58 stores software instructions for performing the exemplary method described below with reference to FIG. 7, which are executed by the processor 54. In particular, the processor 54 and memory 58 are configured for interpreting touch manipulation of the filtering dials 26, 28, and modifying the position of the target window 22 and subset 14 of displayed images 16 in response thereto. Specifically, the instructions include a navigation system 70 including a navigation map control component (map controller) 72 and a visual display control component (mosaic controller) 74. The map controller 72 controls display of the navigation map 18 and is responsive to signals representative of finger or other object touches on the dynamic multi-touch controls 26, 28. The mosaic controller 74 controls the display of images 16 in the mosaic 14 corresponding to the current target window 22 in the navigation map 18. A query generation component 76 may receive signals from the display and/or an associated key entry device and generate a query based thereon for retrieving the set of images.

The system 1 has access to one or more databases 80, 82 of graphic objects, such as images and/or color palettes. The databases 80, 82 may be stored in non-transitory memory, such as local memory 56 and/or may be accessible on a remote server computer 84 via a wired or wireless link 86 to interface 62. Link 86 may be a local area network or a wide area network, such as the Internet. The query generation component 76 may include or access a search engine for generating a query in a suitable query language for identifying graphic objects 16 in the database 80, 82 that are responsive to the query.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The memory 56, 58 may represent any type of tangible computer readable medium such as random access memory (RAM), read only memory (ROM), magnetic disk or tape, optical disk, flash memory, or holographic memory. In one embodiment, the memory 56, 58 comprises a combination of random access memory and read only memory. In some embodiments, the processor 54 and memory 56 and/or 58 may be combined in a single chip. Memory 58 stores instructions for performing the exemplary method as well as the general operation of the computing device 50. The network interface 62 allows the computer 50 to communicate with other devices via a computer network, such as a local area network (LAN) or wide area network (WAN), or the internet, and may comprise a modulator/demodulator (MODEM).

The digital processor 54 can be variously embodied, such as by a single-core processor, a dual-core processor (or more generally by a multiple-core processor), a digital processor and cooperating math coprocessor, a digital controller, or the like. The digital processor 54, in addition to controlling the operation of the computer 50, executes instructions stored in memory 58 for performing the method outlined in FIG. 7.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 1. Since the configuration and operation of programmable computers are well known, they will not be described further.

With reference to FIG. 7, an exemplary method for manipulation of graphic objects 16 which may be implemented with the system 1 illustrated in FIGS. 1-6 is shown. The method begins at S100.

At S102, a user may formulate a query, which is received by the system. The query may be formulated using the tangible objects 40, 42, as described in copending application Ser. No. 12/976,196 or may be input by a keyboard, keypad, touch screen, or the like connected with the system 1.

At S104, images 16 which are responsive to the query are retrieved by the system and may be temporarily stored in local memory 56. In other embodiments, S102 and S104 may be omitted if the user opts to work on the entire database 80.

At S106, user-selected features are received.

At S108, the retrieved images are ordered in clusters, based on their values of the selected features, and information on the clustering is stored in memory 58.

At S110, a navigation map 18 is generated, based on the clusters, and stored in memory 58, and a target window 22 in a default position on the map is generated.

At S112, a mosaic 14 is generated corresponding to the default target window and is stored in memory 58.

At S114, the navigation map 18 and mosaic 14 are displayed on the screen 30 to the user.

At S116, signals corresponding to user manipulation of the control(s) 26, 28 are received.

At S118, based on the received signals, the target window 22 is changed on the navigation map 18 and the mosaic view 14 is modified correspondingly.

At S120, a user may open or select an image 16.

At S122, a user may build a query based on a selected image 16 and/or additional query elements. The method may then return to S102, where responsive images are retrieved and, if the user does not change the selected features at S106, the previously selected features may be reused in the cluster ordering at S108.

The method ends at S124. As will be appreciated, the method need not proceed exactly as shown in FIG. 7 and may return to an earlier step at the selection of a user. For example, if the user does not find interesting images, the query may be modified. For example, the user may generate a new query or a refined query based on one or more of the graphic objects 16 displayed in the mosaic. Or the user may decide that the selected features do not provide helpful clustering and may chose different features (S106).

The method illustrated in FIG. 7 may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 7, can be used to implement the exemplary method for retrieval, manipulation and display of graphic objects.

Further details of the system and method will now be described.

### A. Database Navigation

Navigation of the image search space (the set of graphic objects) is achieved through the combined use of the navigation map 18 and the image mosaic 14 through multi-touch and direct manipulation controls 26, 28. This navigation/browsing can be performed either on the whole database 80, 82 or on a part of it after a query formulation (S102, S104). The navigation system 70 can perform in similar way in both cases.

As illustrated in FIGS. 1, 3, and 4, the system 1 makes available the two filtering dials 26, 28 which are associated, in memory 56, 58, with two user-defined image features. The two features C₁ and C₂ can be selected, by a user, from a predefined set of features, such as color-related features and meta-data related features. The set of selectable features may be presented to the user as a menu 88 (FIG. 4). For example, the exemplary menu includes selectable icons 90, 92 on one or more of the dials 26, 28, each icon corresponding to a respective one feature (or to a set of features, from which a single feature is selectable through a sub-menu). The user touches the icons 90, 92 for the two features of interest, e.g., with a predefined gesture, such as a single or double tap on the screen 30 over the icon. Other methods for selecting the two features are contemplated. In the illustrated embodiment, the icons 90, 92 representing the selectable features are displayed on an outer, menu ring 88 of the dial 26. An inner ring 96 of the dial 26 is used for scrolling the window 22 in x or y direction. In some embodiments, a first of the set of features may be selectable through one dial 26 and a second of the set of features may be selectable though the other dial 28.

The chosen features C₁ and C₂ are used to pre-define uniform intervals in x and y dimensions where each image 16 in the search space is assigned to a respective single one of the clusters 34. Accordingly, some clusters 34 may have no images 16 assigned to them and one or more clusters has at least one image assigned to it. Generally, one or more of the clusters 34 has two or more images assigned to it. The average number of images assigned to a cluster 34 will depend on the total number of images in the search space and the number of clusters. The navigation map 18 shows the distribution of the image clusters 34 along the feature axes. In particular, each square in an array of squares (or other-shaped objects) graphically represents a respective cluster 34 and the density (from opaque to completely transparent) of the square represents the number of images 16 in that cluster 34. It is to be appreciated, however, that another property of the cluster object can be used to represent the number of images in that cluster. For example, the clusters 34 can be colored or otherwise graphically denoted to represent the quantity of images that they each contain. In other embodiments, for example, clusters 34 which include at least one image 16 are colored white and the rest, black, or a number, representing the number of images in that cluster, may be displayed on each cluster, or a stack of squares may be visualized, which is proportional to the number of images 16 in that cluster. Additionally, while the exemplary squares 34 shown in the navigation map 18 do not display any of the respective images in the cluster or any portion thereof, in some embodiments, the clusters may be represented in the navigation map by an exemplary thumbnail image.

The selectable features can be related to different aspects of the image 16. As will be appreciated, the method is not limited to any specific features of the images and the number of user-selectable features can be, for example, from three to one hundred, or more. Exemplary selectable features can include one or more of:

1. Low level image features, such as resolution, redness, blueness, hue, brightness, contrast, blur, saturation, and the like;

2. Image quality or emotional dimensions such as activity, power, valence, arousal, and the like;

3. Image metadata, such as image price, date, time, image usage rights, focal length, shooting time, longitude or latitude (from GPS), image size, and the like; and

4. Image category, which may be a pre-computed confidence output of a visual categorizer trained on a set of visual categories, such as outdoor, landscape, portrait, sad, party, sunrise, vehicle, and the like.

A preselected group of these features can each be quantized in a reference interval and presented to the user through the dial 26, 28. In some embodiments, values of the features are pre-computed for each image 16 and are stored in the database 80, or elsewhere in memory. In other embodiments, values of the selected features are computed online, e.g., on a retrieved set of images.

Some features, such as the image category, can be based on multi-dimensional low level features extracted from the image 16, then expressed as single valued features within a predetermined range. For example confidence on an image category may be a single value output of a classifier that is based on complex low level (SIFT-like and color) image representations and/or high level image representations, such as Fisher Vectors, both of which are referred to herein as image signatures. Briefly, the method of assigning an image category may include extracting low level features from patches of an image (such as gradient and color features), generating an image signature therefrom, and classifying the image into one or more categories using a classifier (or a set of classifiers, one for each category) which has been trained on a labeled set of training samples. If the category assignment is probabilistic over all categories, the most probable category may be assigned to the image. Such methods are described, for example, in U.S. Pat. No. 7,099,860; U.S. Pub. Nos. 20030021481, 2007005356, 20070258648, 20080069456, 20080240572, 20080317358, 20100040285, 20100092084, 20100098343, 20110026831; U.S. application Ser. Nos. 12/512,209 and 12/693,795; and in Perronnin, et al., “Fisher Kernels on Visual Vocabularies for Image Categorization,” in Proc. of the IEEE Conf. on Computer Vision and Pattern Recognition (CVPR), Minneapolis, Minn., USA (June 2007); and Perronnin, et al., “Large-scale image retrieval with compressed Fisher Vectors,” in CVPR 2010, the disclosures of all of which are incorporated herein in their entireties by reference.

Methods for determining features related to image quality are described, for example, in U.S. Pat. Nos. 5,357,352, 5,363,209, 5,371,615, 5,414,538, 5,450,217; 5,450,502, 5,802,214 to Eschbach, et al., U.S. Pat. No. 5,347,374 to Fuss, et al., U.S. Pub. No. 2003/0081842 to Buckley, and U.S. Pat. No. 7,711,211 to Snowdon, et al.

The navigation map 18 can be built (S110) as follows. The two features (characteristics), denoted by C₁ and C₂, are the user-selected features selected with the two filtering dials 26, 28. The dials are used to select features for a set of images which may be retrieved, e.g., based on a user-input query. The query (S102) can be generated in any way and may be completely independent of the selected features. The features C₁ and C₂ can thus be selected (S106) before or after the set of images is retrieved (S104). Let R denote the set of images that was retrieved with a given query. For purposes of explanation, is not of particular relevance what the actual query was or how the search was made. Then the navigation map 18 can be built, as follows.

The system 1 retrieves or computes the values of the features C₁ and C₂ for each image IεR. As previously noted, some features, such as price or date, may be extracted from the dataset and other features, such as redness or mean hue value can be computed on line. Then the minimum and maximum values for each feature (M₁=max(C₁), m₁=min(C₁), M₂=max(C₂), and m₂=min(C₂)) are computed on the set R of retrieved images. Let K×L be the number of image clusters 34 to be represented in the navigation map 18. In some embodiments, K and L may be default values or computed based on the screen size. In other embodiments, they may be user-selectable.

Then the C₁ space is split into K equal parts and the C₂ space is split into L equal parts. For example, if the values of a feature range from 0-1, the C₁ space may be split into ten equal increments of 0.1. Alternatively, the increments may be selected so that the same number of images is in each part. Each image is then assigned to the corresponding cluster, k,l based on its feature values C₁ and C₂, as follows:

$$k = min ( floor ( \frac{( {C}_{1} - {m}_{1} ) \cdot K}{( {M}_{1} - {m}_{1} )} ) + 1 ) , K , and$$

$$l = min ( floor ( \frac{( {C}_{2} - {m}_{2} ) \cdot L}{( {M}_{2} - {m}_{2} )} ) + 1 ) , L$$

“Floor” is a rounding function which rounds to the smallest integer. For example, floor(0/1+1) rounds to 1, and since this is less than K, then k=1. This distribution of images over the clusters can be performed very quickly. The corresponding counting of the images in each cluster (k,l) is also readily performed.

The map 18 is easy to navigate by the user using touch gestures. In one embodiment, the gestures simulate turning the dials 26, 28. In one embodiment, a first of the dials 26 moves the target window 22 from right to left, or vice versa, i.e., in the first feature _{c1} direction, in increments of one cluster width. The second dial 28 is used to control movement of the window 22, in increments of one cluster width, from top to bottom, or vice versa, i.e., in the _{C2} feature direction. The window 22 can thus be translated in any direction within the navigation map 18 by using one or both controls 26, 28, as illustrated in FIG. 3. The controls 26, 28 are set such that the window 22 is contained, at all times entirely within the four borders of the navigation map 18. The system 1 updates the corresponding image mosaic 14 in real time. For example, if the window 22 is moved up by the length of one cluster, new images are added to the mosaic corresponding to the clusters in the next row of the navigation map that are now within the window 22 and images are deleted from the mosaic corresponding to those in the clusters of the row no longer in the window. The images remaining in the mosaic 14 may be rearranged along the feature axes to reflect the new distribution.

In another embodiment, the user can navigate the search space by touch-dragging the target window 22 on the navigation map 18. For example, a single finger touch on the screen 30 within the area 20 of the window 22, followed by dragging movement across the navigation map 18, causes the window 22 to follow a generally corresponding path, in increments of one cluster length, in the selected direction. The mosaic 14 changes correspondingly, in the same way as described for the movement of the window 22 with the dials 26, 28. In other embodiments, the user places one finger on one (e.g., the top left) corner of the window 22 and another on the opposite (e.g., bottom right) corner and can then adjust the position and/or size of the window 22 by dragging one or both of these fingers across the screen 30. In yet other embodiments, tangible selectors, such as knobs, sliders, or the like can be used for moving the target window 22.

The content of the viewing pane 14 is dynamically linked to the navigation map 18, and displays at least some of the subset of images that are contained in the clusters displayed in the target window 22 in the navigation map. The images can be arranged in any order in the mosaic 14. The exemplary image mosaic 14 is a viewing pane that displays image thumbnails 16 in an x by y grid, where x and y can each be, for example, from 3 to about 20, i.e., in several rows and columns. In some embodiments, the arrangement is generally by feature, with the images assigned to the cluster nearest the top left of the target window 22 appearing nearest the top left corner of the mosaic 14, and so forth. Since the clusters 34 are not of equal size, in terms of numbers of images, the location of an image 16 in the mosaic will not necessarily correspond exactly to the location of its cluster in the target window 22. In another embodiment, the images are arranged in the mosaic by feature, as described, for example, in U.S. application Ser. No. 12/693,795.

If the target window 22 contains more images 16 than can be displayed in the image mosaic 14 (there may be a preset maximum number of images which can be displayed at one time), the user can navigate within the target space, e.g., by using one or both the filtering dials 26, 28 to shift the image mosaic along the x and y axes. To shift the filtering dials 26, 28 from the navigation map control to control of the mosaic 14, the user may be required to perform a predefined gesture, such as a tap on or near the mosaic 18. The movement of the filtering dials 26, when used on the mosaic 14, therefore does not change the window position in the navigation map 18.

In other embodiments, the size of the target window 22 may be adjustable. For example, if the user moves the target window 22 to a region of the map 18 where there are relatively few images, the target window may grow in size (which may or may not be visually displayed), along one or more of its four borders, to include more clusters and thereby encompass the maximum number of images which can be accommodated at one time in the mosaic 14. Or, if the window encompassed more images than can be displayed, the target window may decrease in size, along one or more of its four borders.

As will be appreciated, the exemplary navigation map 18 has two dimensions, one for each of two features. It is contemplated that a three dimensional navigation map 18 could be visualized, i.e., permitting three features to be selected. The mosaic 14 would still be two dimensional, showing the images which are in the clusters 34 positioned within a three-dimensional window (now shaped like a block rather than a rectangle). Three filtering dials could be provided in this embodiment.

The combination of the navigation map 18 and the image mosaic 14 allows users to use customizable visual features to dynamically organize and explore the entire search space, without having to click through multiple pages of results. This allows for a more thorough exploration of the results of a textual or other search query. In this way, a user can quickly browse all or a part of a large collection of images and find images which are of particular interest to the user.

### B. Image Manipulation

Various types of image manipulation are contemplated. These may be each initiated by a respective predefined user gesture which is recognized by the system.

In one embodiment, individual images 16 in the image mosaic 14 can be previewed by holding a finger 46 over the image, as shown, for example, in FIG. 5. Previewing can involve displaying an enlarged and/or increased pixel resolution version 96 of the same image 16 displayed in the mosaic.

In another embodiment, individual images 16 can be “opened,” for example, by double tapping or with a multi-touch gesture, such as two fingers at opposite corners of a thumbnail moving in opposite directions to simulate stretching the image open, to display the highest resolution version of the image 16 available:

When an image is opened (FIG. 6), in addition to a full resolution view of the image 16, additional information may be displayed, such as a color palette 98, or other metadata which is associated with the image in memory, such as pricing and licensing information, textures, shapes, and the like. Opening the image 16 allows users to consult the available metadata. The multi-touch interface 10 can be used to extract parts of an image 16, to trace shapes and contours in an image, or to select features of an image, such as its color palette., any or all of which can then be stored as individual elements in a light box 100, e.g., for later review, or as elements for formulating a further query. For example, in FIG. 6, the user is using a predefined two hand gesture for tracing a shape on the image 16. One hand touches the image and maintains a static contact, simulating holding it, while the other hand is used for a dynamic contact-tracing the desired shape. This shape could be dragged to the light box 100 and/or used to formulate a query.

### C. Dynamic Query Weighting

While the exemplary system 1 allows simple queries ordered by relevance feedback, in one embodiment, the system goes beyond simply binary relevance where the user selects the relevant (and/or non-relevant) exemplary elements (e.g., images, color palette, GPS coordinates, Time, Author, and/or other metadata). Complex query formulation may be provided with the dynamic interface 10.

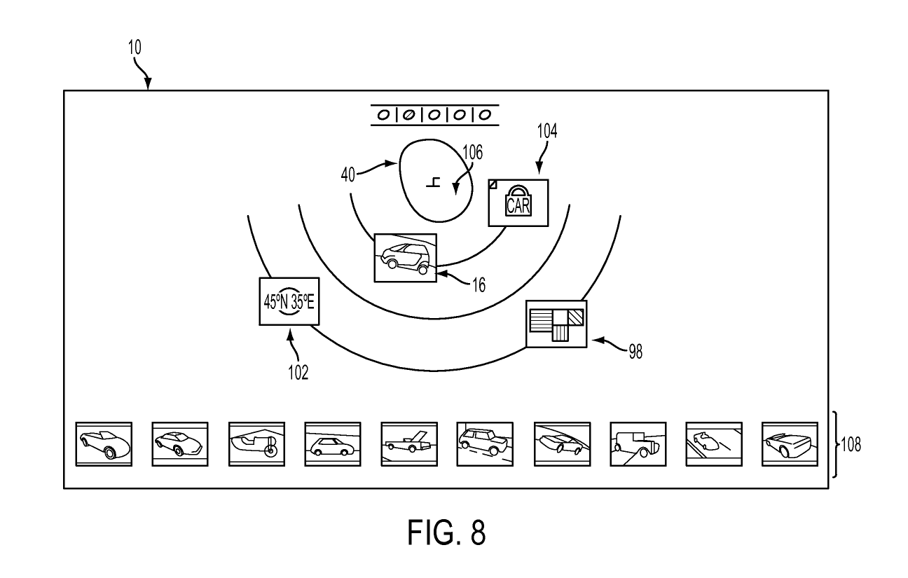

For example, as illustrated in FIG. 8, a user can select various elements for generating a query. In the illustrated embodiment, the user has selected to generate a query based on a selected image 16, a selected color palette 98, a GPS position 102, and one or more keywords 104, which are identified by respective icons on the interface 10. Fewer, more, or different query elements could, of course be selectable. The relative importance (weights) of each of the elements of the query can be changed by moving the respective icon 16, 98, 102, 104 closer to or further away from a visually represented query center 106. As the different elements 16, 98, 102, 104 in the query are moved and hence the weights updated, the top retrieved graphic objects may be displayed in real time (e.g. in a row, at 108), allowing the user to fine tune these weights. In the illustrated example, the user has selected to put most weight on the selected image 16 and chosen keyword(s) 104, with lesser weight placed on the GPS coordinates 102 and color palette 98.

When the user-selected query weights are finalized, the user can browse through the retrieved graphic objects (e.g., if the retrieved set is large) using the navigation map 18 and the image mosaic 14 as described in section A, above.

To provide for efficient image retrieval and display, in the complex query mode, the system may initially retrieve a large but reasonably sized set of images, either by applying an equal weighting or with a filtering by each query element in order to pre-select a set S of images I₁, . . . I_{N} with a size which is sufficiently large but still reasonable. For all those images, the distances to the query elements are then computed. For example, if the query contains image I_{q}, a palette P_{q} and a GPS location G_{q}, then a distance from the respective image, palette and GPS location of each image in the set S to these query elements is computed, i.e., a dist(I_{q},Iₙ), a dist(p_{q},palette(Iₙ)), and a dist(G_{q},GPS(Iₙ)) are computed. The distances are all normalized (e.g., to get values between 0 and 1).

Hence, for a complex query Q with a given set of weights, one weight for each of the query elements, denoted (w^{I},w^{P},w^{G}), the new distance to each image in the set can be computed as a weighted sum of the precomputed distances for each of the query elements:

dist(Q,Iₙ)=w^{I}dist(I_{q},Iₙ)+w^{P}dist(p_{q},palette(Iₙ))+w^{G}dist(G_{q},GPS(Iₙ))

The weights of the query elements may each assume values between 0 and 1 under the constraint that all weights sum to a given value, e.g., w^{I}+w^{P+}w^{G}=1.

The images in the set can be re-ranked according to this new distance measure. Hence if the set size S is reasonable, this operation is quickly performed by the system and the top elements shown at 108 can be dynamically updated.

The dynamic querying can be used simply to provide the user with an indication of the type of images which can be retrieved, and only the top images retrieved need be shown in the exemplary embodiment. This process is sufficient to allow the user tune the weights and thus there is no need to search the entire database. However, when the query weights have been established, the query may be applied to the entire database 80, as images not gathered into the set S in the first step may be considered relevant.

For computing the distance dist(I_{q},Iₙ), between a query image 16 and a database image, an image similarity measure based on the distance between image signatures can be used. The image signatures can be Fisher vectors or the like, generated from low level features extracted from patches of the image, as described above for image classification. Other methods based on feature matching can alternatively be used (see, for example, Chen Y., Wang J. Z., “A Region-Based Fuzzy Feature Matching Approach to Content Based Image Retrieval,” IEEE Transactions on Pattern Analysis and Machine Intelligence, vol. 24, n^{o} 9, p. 1252-1267, September, 2002).

For computing a distance dist(p_{q},palette(Iₙ)) between color palettes, the Earth Movers' Distance, Manhattan distance, or the like can be used (see, for example, U.S. application Ser. Nos. 12/890,049, and 12/908,410, the disclosures of which are incorporated herein by reference in their entireties).

Keyword matching may be based on standard techniques, such as matching image tags with the selected keywords, optionally after applying a thesaurus or other query expansion tools.

As images are often accompanied by text and metadata, multi-modal retrieval methods, such as those described in U.S. Application Ser. No. 12/968,796, the disclosure of which is incorporated herein by reference in its entirety, and in Müller, H. and Clough, P. and Deselaers, Th. and Caputo, B., ImageCLEF—Experimental Evaluation in Visual Information Retrieval, Springer The Information Retrieval Series, 2010. ISBN 978-3-642-15180-4 (in particular, the chapter by Ah-Pine, J. and Clinchant, S. and Csurka, G. and Perronnin, F. and Renders, J-M., “Leveraging image, text and cross-media similarities for diversity-focused multimedia retrieval”) may be used for querying the database 80.

The exemplary system can take advantage of such methods, by integrating them in the complex query formulation and refinement and to build the dynamic image mosaic and navigation map.

### D. Exploratory Database Browsing

In some embodiments, the user may be able to select from two or more browsing modes, one of which may be a default mode. One of these modes (query browsing), may be as described above, where the user inputs a query (S102), and responsive graphic objects are retrieved (S104). In another mode (exploratory browsing), the system does not use a query based pre-selection, but randomly selects a predefined number (e.g., a few thousand) of the images in the database (S126), and allows the user to navigate in this image set as described above in Section B. For example, the user initiates the exploratory mode by touching an exploratory browsing icon 110 on the interface 10 (FIG. 1). The user selects two features C₁ and C₂ (S106) and, using the filtering dials 26, 28, can navigate through the navigation map 18 for the random set and visualize the clusters of images within the selected target window 22 dynamically in the mosaic 14.

The exploratory browsing mode allows the user to extend the database exploration space to images which are less accessible through conventional searching. The images 16 visualized during this process can be selected and placed in the light box 100 and/or used to generate a new query (S102) or a complex query (S122) as described above. Similarly the user can select, instead of the whole image, a part of it, or palettes, textures, or forms extracted from it.

The exemplary system and method facilitate retrieving images from a large collection without requiring a fixed compromise between delimiting the search space through explicit criteria and browsing a sufficient number of images out of the total available to ensure the appropriate ones are not missed. It also provides users with an interface that allows effective search, user friendly interaction and efficient visualization. Some advantages which may be achieved with the exemplary system and method include:

1. The use of multi-touch direct manipulation controls 26, 28 in an interface 10 which combines the direct visualization (mosaic 14) of images with a visual representation (map 18) of the distribution of user selected visual and content-based features across a collection of images.

2. Navigation and dynamic re-organization of the search space through the direct manipulation of a feature-based navigation map 18 that provides a visual representation of the distribution of features across the entire set of images and is synchronized with the thumbnail viewing pane 14.

3. A more thorough exploration of large collections of images by adapting content-based retrieval methods to a browsing mechanism which allows the user to define the balance between exploitation (e.g., using content-based technologies and visual features to refine a search space) and exploration (e.g., using content-based technologies and visual features to organize and visually represent the content of a search space).

In addition the system integrates a weighted relevance feedback mechanism, where the dynamic interface 10 allows for a fine tuning of manually selectable weights in a user-friendly manner.

The search space is generally refined, in existing systems, either by reformulating or specifying the textual query (query expansion) or by selecting relevant and non relevant image examples amongst the ones retrieved in previous steps (relevance feedback). The system automatically selects or learns which features have to be highly weighted in the search. In the present system and method, tuning of the relevance weights can be achieved in an easy and user friendly manner. Further, it allows the selection of the relevant features (color, texture, etc.) explicitly.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for manipulation of a set of graphic objects, comprising:
with a computer processor, displaying a navigation map on a user interface, the navigation map representing a set of graphic objects;
providing for a user to manipulate a target window which is displayed on the navigation map, the window encompassing only a subset of the graphic objects; and
displaying graphic objects in the subset of graphic objects on the user interface in synchronization with the displayed target window.

2. The method of claim 1, wherein the navigation map and graphic objects in the subset are displayed contemporaneously in respective areas of the user interface.

3. The method of claim 1, wherein the graphic objects are arranged in an array.

4. The method of claim 1, wherein the graphic objects comprise photographic images.

5. The method of claim 1, wherein the navigation map comprises a two-dimensional array of clusters, each graphic object in the set being assigned to a respective one of the clusters.

6. The method of claim 1, wherein the navigation map includes first and second feature dimensions, each of the graphic objects in the set being associated with a respective value for the first and second features.

7. The method of claim 6, further comprising clustering graphic objects in the set of graphic objects based on respective values of the first and second features, the navigation map comprising an array of cluster objects, each cluster object in the array graphically representing a respective cluster.

8. The method of claim 7, wherein the cluster objects have a property which represents a number of graphic objects in the respective cluster.

9. The method of claim 6, wherein the first and second features are user selectable.

10. The method of claim 9, further comprising displaying a feature selector on the user interface.

11. The method of claim 1, wherein the providing for the user to manipulate a target window comprises displaying at least one controller and providing instructions in memory for recognizing a touch gesture on the controller as representing a movement of the window.

12. The method of claim 11, wherein the displaying of at least one controller comprises displaying first and second controllers, a touch gesture on the first controller being recognized as a movement of the window in a first direction and a touch gesture on the second controller being recognized as a movement of the window in a second direction, orthogonal to the first direction.

13. The method of claim 1, wherein the set of graphic objects are retrieved from a database in response to a query or by random selection.

14. The method of claim 13, wherein the set of graphic objects are retrieved in response to a query, the method further comprising providing for generating a weighted query with the interface, the weighted query being generated by first and second query objects at relative distances from a query center, the distances representing respective weights of query elements in the query, the query elements being based on the query objects, at least one of the query objects being one of the displayed graphic objects.

15. The method of claim 1, further comprising displaying metadata associated with one of the displayed graphic objects in response to a touch gesture on the graphic object.

16. A computer program product comprising a tangible recording medium encoding instructions, which when executed by a computer, perform the method of claim 1.

17. A system comprising memory which stores instructions for performing the method of claim 1 and a computer processor in communication with the memory for executing the instructions.

18. A system for manipulation of graphic objects, comprising:
a user interface comprising a display device;
memory which stores instructions for:
displaying a navigation map on the display device, the navigation map representing a set of graphic objects;
interpreting signals representative of user touches on the display device as manipulation of a target window which is displayed on the navigation map, and moving the target window in response thereto, the window encompassing only a subset of the graphic objects; and
displaying graphic objects in the subset of graphic objects on the display device, the display of graphic objects changing in synchronization with the movement of the target window; and
a computer processor in communication with the memory for implementing the instructions.

19. The system of claim 18, wherein the display device comprises a touch screen device and wherein the user manipulates the target window with touch gestures.

20. The system of claim 18, wherein the navigation map visualizes clusters of graphic objects, the graphic objects being assigned to a respective cluster based on values of first and second features.

21. The system of claim 20 wherein the memory includes instructions for computing values of at least one of the user selectable features for the set of graphic objects based on information extracted from the graphic objects.

22. A method comprising:
retrieving a set of graphic objects;
clustering the graphic objects into clusters, based on values of first and second user-selected features assigned to the graphic objects;
displaying a navigation map on a user interface, the navigation map representing the clusters of graphic objects as an array of cluster objects arranged in first and second dimensions corresponding to the first and second features;
receiving signals representative of user manipulation of a target window which is displayed on the navigation map, the displayed target window encompassing only a subset of the cluster objects; and
displaying graphic objects in the subset of graphic objects on the user interface corresponding to the subset of cluster objects within the displayed target window.

23. The method of claim 22, wherein at least one of the clustering, displaying of the navigation map, receiving of signals, and displaying of graphic objects is performed with a computer processor.
